(19) United States
(12) Patent Application Publication
(10) Pub. No.: US 2024/0286652 A1
(43) Pub. Date: Aug. 29, 2024

(54) TIMING SHADOW ADS APPLICATION BASED ON ODD BOUNDS

(71) Applicant: WOVEN ALPHA, INC., Tokyo (JP)

(72) Inventors: Manuel Ludwig Kuehner, Mountain View, CA (US); Hiroshi Yasuda, San Francisco, CA (US)

(21) Appl. No.: 18/174,509

(22) Filed: Feb. 24, 2023

(51) Int. Cl. B60W 60/00; B60W 40/08; B60W 50/14

(52) U.S. Cl. CPC B60W 60/0057; B60W 40/08; B60W 50/14; B60W 60/0015; B60W 60/0053; B60W 2050/143; B60W 2050/146; B60W 2555/20; B60W 2556/10

(57) ABSTRACT

Systems and methods are provided for applying shadow assisted driving systems (ADS) to a vehicle. The system can receive sensor data and deliver a takeover request to the vehicle operator based on the sensor data. An end boundary can be determine to disengage an ADS feature from the vehicle. A disengage boundary can be set where the vehicle can disengage before the end boundary. The system can determine when the vehicle operator responds to the takeover request based on the sensor data, which can cause the ADS to shadow the vehicle operator based on a determination that the vehicle operator did not take over operation of the vehicle at the disengage boundary.

### TECHNICAL FIELD

The present disclosure relates generally to automated driving systems (ADS) and, and in particular, some implementations may relate to the adaptation of ADS in situations where ADS capabilities are limited.

### DESCRIPTION OF RELATED ART

ADS can be applied in various situations to reduce the burden on a driver. ADS capabilities may range from semi-automatic to fully automatic operation, depending on the automated action and applicable environment. However, vehicles may transition between different environments that alter the level of automatic operation available. In these situations, the ADS can be adjusted accordingly or control can be returned to the driver.

### BRIEF SUMMARY OF THE DISCLOSURE

According to various embodiments of the disclosed technology, a method for applying shadow assisted driving systems (ADS) to a vehicle can comprise receiving sensor data; delivering a takeover request to the vehicle operator based on the sensor data; determining an end boundary to disengage an ADS feature from the vehicle; setting a disengage boundary that occurs before the end boundary; determining when the vehicle operator responds to the takeover request based on the sensor data; and causing the ADS to shadow the vehicle operator based on a determination that the vehicle operator did not take over operation of the vehicle at the disengage boundary.

In some embodiments, the method further comprises activating a safety feature at the disengage boundary or maintaining the safety feature if already activated.

In some embodiments, the sensor data comprises data on the driver's character.

In some embodiments, delivering the takeover request comprises displaying a visual or audio indicator to the driver.

In some embodiments, the method further comprises delivering the takeover request for a time interval before activating a safety feature.

In some embodiments, the time interval is based on the sensor data, environmental data, historical driving performance, or cloud data.

In some embodiments, the time interval is a value set by the driver.

In some embodiments, the method further comprises determining, based on the sensor data, that the driver requires additional time to accept the takeover request; and extending the time interval.

In some embodiments, the end boundary comprises a latest time the vehicle can apply the ADS feature.

In accordance with another embodiment of the disclosed technology, a control system for a vehicle can comprise a processor; and a memory coupled to the processor to store instructions, which when executed by the processor, cause the processor to: receive sensor data; determine an end boundary to disengage an ADS feature from the vehicle; set a disengage boundary that occurs before the end boundary; deliver a takeover request for a time interval to the vehicle operator based on the sensor data and the disengage boundary; determine when the vehicle operator responds to the takeover request based on the sensor data; and cause the ADS to shadow the vehicle operator based on a determination that the vehicle operator did not take over operation of the vehicle at the disengage boundary.

In some embodiments, the processor is further configured to activate a safety feature at the disengage boundary.

In some embodiments, delivering the takeover request comprises displaying a visual or audio indicator to the driver.

In some embodiments, the time interval is based on the sensor data, environmental data, and historical driving performance.

In some embodiments, the time interval is a value set by the driver.

In some embodiments, the processor is further configured to: determine, based on the sensor data, that the driver requires additional time to accept the takeover request; and extend the time interval.

In some embodiments, the end boundary comprises a latest time the vehicle can apply the ADS feature.

In accordance with another embodiment of the disclosed technology, a non-transitory machine-readable medium can have instructions stored therein to cause a processor to: receive sensor data; determine an end boundary to disengage an ADS feature from a vehicle; set a disengage boundary that occurs before the end boundary; deliver a takeover request for a time interval to the vehicle operator based on the sensor data and the disengage boundary; determine when the vehicle operator responds to the takeover request based on the sensor data; and cause the ADS to shadow the vehicle operator based on a determination that the vehicle operator did not take over operation of the vehicle at the disengage boundary.

In some embodiments, the sensor data comprises data on the driver's character.

In some embodiments, the processor is further caused to transmit the takeover request for a time interval before activating a safety feature.

In some embodiments, the time interval is based on the sensor data, environmental data, and historical driving performance.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 is a schematic representation of an example hybrid vehicle with which embodiments of the systems and methods disclosed herein may be implemented.

FIG. 2 illustrates an example architecture for ADS systems in accordance with one embodiment of the systems and methods described herein.

FIGS. 3A-3B illustrate example situations for applying shadow ADS.

FIG. 4 illustrates an example method in accordance with the embodiment described herein.

FIG. 5 is an example computing component that may be used to implement various features of embodiments described in the present disclosure.

The figures are not exhaustive and do not limit the present disclosure to the precise form disclosed.

### DETAILED DESCRIPTION

ADS (automated driving systems) can operate at various levels of automation. ADS capabilities can be ranked at levels zero to five. For example, as of 2021, the Society of Automotive Engineers (SAE) updated its standard for the Levels of Driving Automation™ to SAE 3016_202104. At level zero, the ADS is capable of momentary driving assistance. The driver can be fully responsible for driving the vehicle while the vehicle provides warnings, alerts, or emergency safety interventions. For example, at level zero, the vehicle may instruct the driver to brake the vehicle when the vehicle is very close to another object. The vehicle may apply emergency braking when the vehicle is too close to the object. At level one, the ADS is capable of providing continuous assistance while the driver is fully responsible for driving the vehicle. Examples can include applying steady braking, acceleration, or steering assistance. At level two, the ADS can provide continuous assistance with acceleration, braking, and steering. As an example, a driver may have cruise control activated and automatic lane maintenance while driving on a straight highway. At level three, the ADS can control all aspects of driving. The driver can remain available to take over the system if ADS is no longer operable. At level four, the system is fully responsible for driving tasks. This capability can be limited to specific service areas. At level four, a human driver is not needed to operate the vehicle. At level five, the system is fully automated and can operate under all conditions and on all roadways.

The systems and methods disclosed herein may apply to ADS operating at level two or three. In particular, shadow ADS can be applied to facilitate driver takeovers. Here, shadow ADS refers to the system's ability and actions to transition out of an ADS feature when the driving environment is outside the system's capabilities. For example, a vehicle with control of the steering wheel may not be able to operate when a vehicle exits the highway onto an exit ramp. Shadow ADS can be engaged to transition the vehicle safely away from the ADS feature. The vehicle system can transfer control to the driver and turn off the ADS feature. Alternatively, the system can apply lower-level safety features to slow down or stop the vehicle in a safe area.

These takeover requests or safety features can be applied at a time suitable for the safety of the vehicle. The systems and methods disclosed herein can determine when to provide a takeover request based on an Operational Design Domain (ODD) boundary. Here, the ODD boundary can refer to the area where an ADS feature was designed to operate in. The ODD bound can be determined in terms of the latest point in time or space an ADS system can be applied before capabilities are exceeded. The ODD bound can be determined based on environmental conditions, driving conditions, driver actions or mistakes, or specific situations affecting the safety of the driver. Example events can include leaving a lane unintentionally, swerving off a road, or hitting an obstacle.

The system can determine a time to send a takeover request to a driver based on an apparent ODD bound. The apparent ODD bound can refer to the boundary where a vehicle should activate safety features such as slowing down the vehicle, pulling over, etc. The driver may only be aware of the apparent ODD bound (i.e. with a visual or audio indicator) and may not receive indicators that the vehicle has reached the ODD bound. Safety features may be activated at the ODD bound; however, this produces significant risk as the vehicle may have less time to safely activate safety features. For example, if the ODD bound is an object blocking a road, activating safety features right before the object may result in an accident. As another example, if the ODD bound is a curving exit ramp, activating safety features at the curve may cause the vehicle to veer off the road. The apparent ODD bound can be a boundary applied earlier than the ODD bound to reduce or eliminate this risk by providing the vehicle system additional time to activate safety features based on the driving conditions.

Takeover requests may be determined based on the apparent ODD bound and a specific driver's conditions. For example, if a driver is fatigued, it may take the driver a longer time to come to full attention and takeover control of the vehicle. As another example, a driver may have a longer reaction time to apply brakes. The takeover request may be issued earlier to account for this increased reaction time. The system can determine these conditions by receiving various data on the driver. Data may reflect historical driving performance, sensor data (e.g. video or facial recognition), driving trends of the local population, or other factors that affect a driver's performance. The system can consider all of the available data to tailor a takeover request to the specific driver.

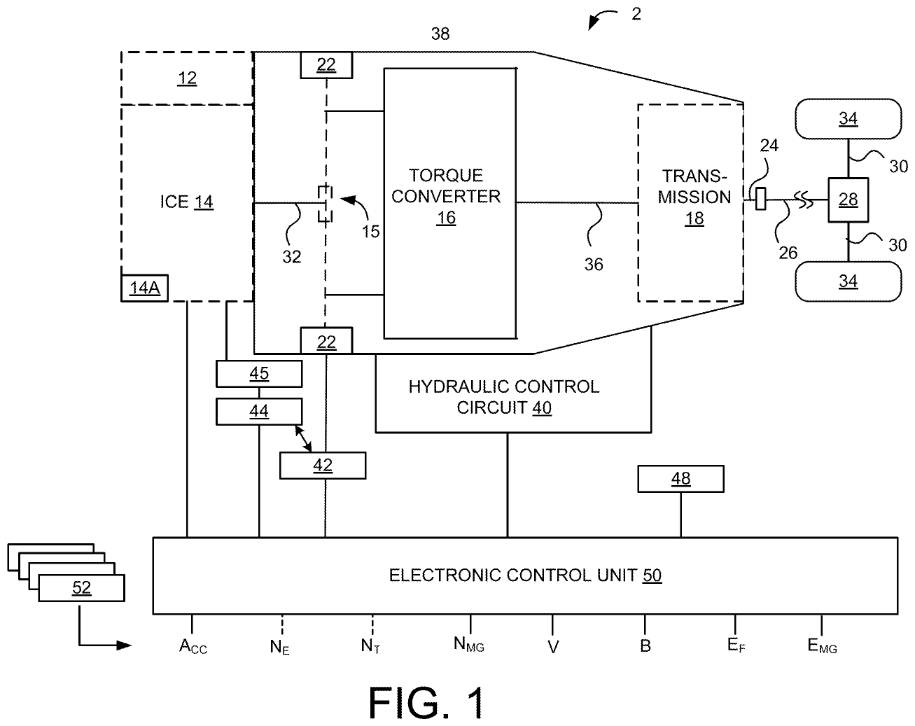

The systems and methods disclosed herein may be implemented with any of a number of different vehicles and vehicle types. For example, the systems and methods disclosed herein may be used with automobiles, trucks, motorcycles, recreational vehicles and other like on-or off-road vehicles. In addition, the principals disclosed herein may also extend to other vehicle types as well. An example hybrid electric vehicle (HEV) in which embodiments of the disclosed technology may be implemented is illustrated in FIG. 1. Although the example described with reference to FIG. 1 is a hybrid type of vehicle, the systems and methods for applying shadow ADS can be implemented in other types of vehicle including gasoline- or diesel-powered vehicles, fuel-cell vehicles, electric vehicles, or other vehicles.

FIG. 1 illustrates a drive system of a vehicle 100 that may include an internal combustion engine 14 and one or more electric motors 22 (which may also serve as generators) as sources of motive power. Driving force generated by the internal combustion engine 14 and motors 22 can be transmitted to one or more wheels 34 via a torque converter 16, a transmission 18, a differential gear device 28, and a pair of axles 30.

As an HEV, vehicle 2 may be driven/powered with either or both of engine 14 and the motor(s) 22 as the drive source for travel. For example, a first travel mode may be an engine-only travel mode that only uses internal combustion engine 14 as the source of motive power. A second travel mode may be an EV travel mode that only uses the motor(s) 22 as the source of motive power. A third travel mode may be an HEV travel mode that uses engine 14 and the motor(s) 22 as the sources of motive power. In the engine-only and HEV travel modes, vehicle 100 relies on the motive force generated at least by internal combustion engine 14, and a clutch 15 may be included to engage engine 14. In the EV travel mode, vehicle 2 is powered by the motive force generated by motor 22 while engine 14 may be stopped and clutch 15 disengaged.

Engine 14 can be an internal combustion engine such as a gasoline, diesel or similarly powered engine in which fuel is injected into and combusted in a combustion chamber. A cooling system 12 can be provided to cool the engine 14 such as, for example, by removing excess heat from engine 14. For example, cooling system 12 can be implemented to include a radiator, a water pump and a series of cooling channels. In operation, the water pump circulates coolant through the engine 14 to absorb excess heat from the engine. The heated coolant is circulated through the radiator to remove heat from the coolant, and the cold coolant can then be recirculated through the engine. A fan may also be included to increase the cooling capacity of the radiator. The water pump, and in some instances the fan, may operate via a direct or indirect coupling to the driveshaft of engine 14. In other applications, either or both the water pump and the fan may be operated by electric current such as from battery 44.

An output control circuit 14A may be provided to control drive (output torque) of engine 14. Output control circuit 14A may include a throttle actuator to control an electronic throttle valve that controls fuel injection, an ignition device that controls ignition timing, and the like. Output control circuit 14A may execute output control of engine 14 according to a command control signal(s) supplied from an electronic control unit 50, described below. Such output control can include, for example, throttle control, fuel injection control, and ignition timing control.

Motor 22 can also be used to provide motive power in vehicle 2 and is powered electrically via a battery 44. Battery 44 may be implemented as one or more batteries or other power storage devices including, for example, lead-acid batteries, nickel-metal hydride batteries, lithium ion batteries, capacitive storage devices, and so on. Battery 44 may be charged by a battery charger 45 that receives energy from internal combustion engine 14. For example, an alternator or generator may be coupled directly or indirectly to a drive shaft of internal combustion engine 14 to generate an electrical current as a result of the operation of internal combustion engine 14. A clutch can be included to engage/disengage the battery charger 45. Battery 44 may also be charged by motor 22 such as, for example, by regenerative braking or by coasting during which time motor 22 operate as generator.

Motor 22 can be powered by battery 44 to generate a motive force to move the vehicle and adjust vehicle speed. Motor 22 can also function as a generator to generate electrical power such as, for example, when coasting or braking. Battery 44 may also be used to power other electrical or electronic systems in the vehicle. Motor 22 may be connected to battery 44 via an inverter 42. Battery 44 can include, for example, one or more batteries, capacitive storage units, or other storage reservoirs suitable for storing electrical energy that can be used to power motor 22. When battery 44 is implemented using one or more batteries, the batteries can include, for example, nickel metal hydride batteries, lithium ion batteries, lead acid batteries, nickel cadmium batteries, lithium ion polymer batteries, and other types of batteries.

An electronic control unit 50 (described below) may be included and may control the electric drive components of the vehicle as well as other vehicle components. For example, electronic control unit 50 may control inverter 42, adjust driving current supplied to motor 22, and adjust the current received from motor 22 during regenerative coasting and breaking. As a more particular example, output torque of the motor 22 can be increased or decreased by electronic control unit 50 through the inverter 42.

A torque converter 16 can be included to control the application of power from engine 14 and motor 22 to transmission 18. Torque converter 16 can include a viscous fluid coupling that transfers rotational power from the motive power source to the driveshaft via the transmission. Torque converter 16 can include a conventional torque converter or a lockup torque converter. In other embodiments, a mechanical clutch can be used in place of torque converter 16.

Clutch 15 can be included to engage and disengage engine 14 from the drivetrain of the vehicle. In the illustrated example, a crankshaft 32, which is an output member of engine 14, may be selectively coupled to the motor 22 and torque converter 16 via clutch 15. Clutch 15 can be implemented as, for example, a multiple disc type hydraulic frictional engagement device whose engagement is controlled by an actuator such as a hydraulic actuator. Clutch 15 may be controlled such that its engagement state is complete engagement, slip engagement, and complete disengagement complete disengagement, depending on the pressure applied to the clutch. For example, a torque capacity of clutch 15 may be controlled according to the hydraulic pressure supplied from a hydraulic control circuit (not illustrated). When clutch 15 is engaged, power transmission is provided in the power transmission path between the crankshaft 32 and torque converter 16. On the other hand, when clutch 15 is disengaged, motive power from engine 14 is not delivered to the torque converter 16. In a slip engagement state, clutch 15 is engaged, and motive power is provided to torque converter 16 according to a torque capacity (transmission torque) of the clutch 15.

As alluded to above, vehicle 100 may include an electronic control unit 50. Electronic control unit 50 may include circuitry to control various aspects of the vehicle operation. Electronic control unit 50 may include, for example, a microcomputer that includes a one or more processing units (e.g., microprocessors), memory storage (e.g., RAM, ROM, etc.), and I/O devices. The processing units of electronic control unit 50, execute instructions stored in memory to control one or more electrical systems or subsystems in the vehicle. Electronic control unit 50 can include a plurality of electronic control units such as, for example, an electronic engine control module, a powertrain control module, a transmission control module, a suspension control module, a body control module, and so on. As a further example, electronic control units can be included to control systems and functions such as doors and door locking, lighting, human-machine interfaces, cruise control, telematics, braking systems (e.g., ABS or ESC), battery management systems, and so on. These various control units can be implemented using two or more separate electronic control units, or using a single electronic control unit.

In the example illustrated in FIG. 1, electronic control unit 50 receives information from a plurality of sensors included in vehicle 100. For example, electronic control unit 50 may receive signals that indicate vehicle operating conditions or characteristics, or signals that can be used to derive vehicle operating conditions or characteristics. These may include, but are not limited to accelerator operation amount, A_{CC}, a revolution speed, N_{E}, of internal combustion engine 14 (engine RPM), a rotational speed, N_{MG}, of the motor 22 (motor rotational speed), and vehicle speed, N_{V}. These may also include torque converter 16 output, N_{T} (e.g., output amps indicative of motor output), brake operation amount/pressure, B, battery SOC (i.e., the charged amount for battery 44 detected by an SOC sensor). Accordingly, vehicle 100 can include a plurality of sensors 52 that can be used to detect various conditions internal or external to the vehicle and provide sensed conditions to engine control unit 50 (which, again, may be implemented as one or a plurality of individual control circuits). In one embodiment, sensors 52 may be included to detect one or more conditions directly or indirectly such as, for example, fuel efficiency, E_{F}, motor efficiency, E_{MG}, hybrid (internal combustion engine 14+MG 12) efficiency, acceleration, A_{CC}, etc.

In some embodiments, one or more of the sensors 52 may include their own processing capability to compute the results for additional information that can be provided to electronic control unit 50. In other embodiments, one or more sensors may be data-gathering-only sensors that provide only raw data to electronic control unit 50. In further embodiments, hybrid sensors may be included that provide a combination of raw data and processed data to electronic control unit 50. Sensors 52 may provide an analog output or a digital output.

Sensors 52 may be included to detect not only vehicle conditions but also to detect external conditions as well. Sensors that might be used to detect external conditions can include, for example, sonar, radar, lidar or other vehicle proximity sensors, and cameras or other image sensors. Image sensors can be used to detect, for example, traffic signs indicating a current speed limit, road curvature, obstacles, and so on. Still other sensors may include those that can detect road grade. While some sensors can be used to actively detect passive environmental objects, other sensors can be included and used to detect active objects such as those objects used to implement smart roadways that may actively transmit and/or receive data or other information.

The example of FIG. 1 is provided for illustration purposes only as one example of vehicle systems with which embodiments of the disclosed technology may be implemented. One of ordinary skill in the art reading this description will understand how the disclosed embodiments can be implemented with this and other vehicle platforms.

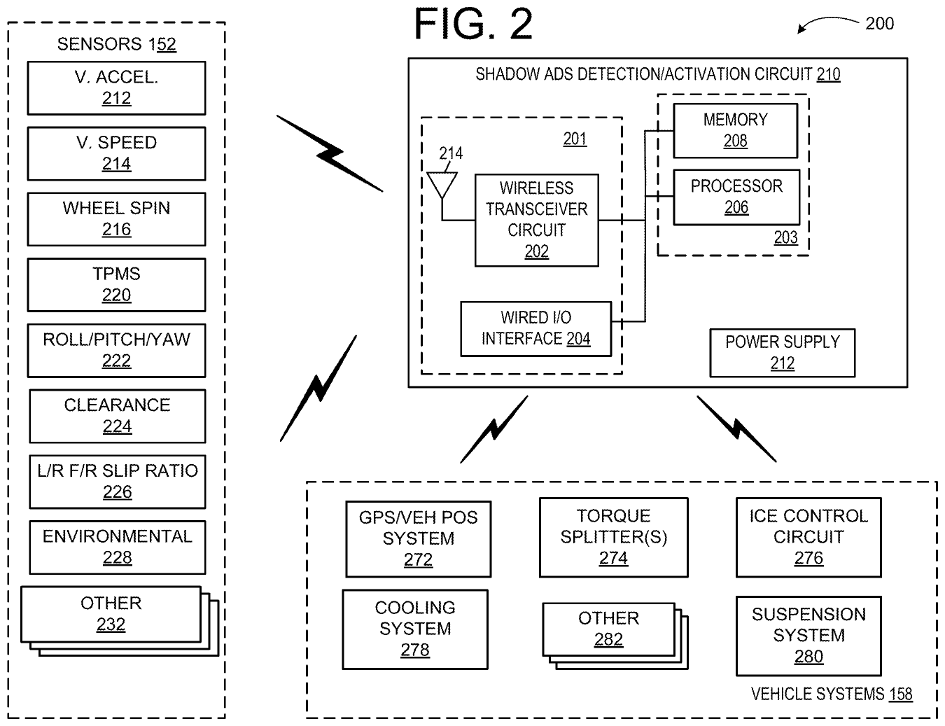

FIG. 2 illustrates an example architecture for detecting shadow ADS scenarios and activating shadow ADS in accordance with one embodiment of the systems and methods described herein. Referring now to FIG. 2, in this example, shadow ADS detection and activation system 200 includes an shadow ADS detection/activation circuit 210, a plurality of sensors 152 and a plurality of vehicle systems 158. Sensors 152 and vehicle systems 158 can communicate with shadow ADS detection/activation circuit 210 via a wired or wireless communication interface. Although sensors 152 and vehicle systems 158 are depicted as communicating with shadow ADS detection/activation circuit 210, they can also communicate with each other as well as with other vehicle systems. shadow ADS detection/activation circuit 210 can be implemented as an ECU or as part of an ECU such as, for example electronic control unit 50. In other embodiments shadow ADS detection/activation circuit 210 can be implemented independently of the ECU.

Shadow ADS detection/activation circuit 210 in this example includes a communication circuit 201, a decision circuit 203 (including a processor 206 and memory 208 in this example) and a power supply 212. Components of shadow ADS detection/activation circuit 210 are illustrated as communicating with each other via a data bus, although other communication in interfaces can be included.

Processor 206 can include one or more GPUs, CPUs, microprocessors, or any other suitable processing system. Processor 206 may include a single core or multicore processors. The memory 208 may include one or more various forms of memory or data storage (e.g., flash, RAM, etc.) that may be used to store the calibration parameters, images (analysis or historic), point parameters, instructions and variables for processor 206 as well as any other suitable information. Memory 208, can be made up of one or more modules of one or more different types of memory, and may be configured to store data and other information as well as operational instructions that may be used by the processor 206 to shadow ADS detection/activation circuit 210.

Although the example of FIG. 2 is illustrated using processor and memory circuitry, as described below with reference to circuits disclosed herein, decision circuit 203 can be implemented utilizing any form of circuitry including, for example, hardware, software, or a combination thereof. By way of further example, one or more processors, controllers, ASICs, PLAS, PALs, CPLDs, FPGAs, logical components, software routines or other mechanisms might be implemented to make up a assist-mode detection/activation circuit 210.

Communication circuit 201 either or both a wireless transceiver circuit 202 with an associated antenna 205 and a wired I/O interface 204 with an associated hardwired data port (not illustrated). As this example illustrates, communications with shadow ADS detection/activation circuit 210 can include either or both wired and wireless communications circuits 201. Wireless transceiver circuit 202 can include a transmitter and a receiver (not shown) to allow wireless communications via any of a number of communication protocols such as, for example, Wifi, Bluetooth, near field communications (NFC), Zigbee, and any of a number of other wireless communication protocols whether standardized, proprietary, open, point-to-point, networked or otherwise. Antenna 205 is coupled to wireless transceiver circuit 202 and is used by wireless transceiver circuit 202 to transmit radio signals wirelessly to wireless equipment with which it is connected and to receive radio signals as well. These RF signals can include information of almost any sort that is sent or received by shadow ADS detection/activation circuit 210 to/from other entities such as sensors 152 and vehicle systems 158.

Wired I/O interface 204 can include a transmitter and a receiver (not shown) for hardwired communications with other devices. For example, wired I/O interface 204 can provide a hardwired interface to other components, including sensors 152 and vehicle systems 158. Wired I/O interface 204 can communicate with other devices using Ethernet or any of a number of other wired communication protocols whether standardized, proprietary, open, point-to-point, networked or otherwise.

Power supply 210 can include one or more of a battery or batteries (such as, e.g., Li-ion, Li-Polymer, NiMH, NiCd, NiZn, and NiH₂, to name a few, whether rechargeable or primary batteries), a power connector (e.g., to connect to vehicle supplied power, etc.), an energy harvester (e.g., solar cells, piezoelectric system, etc.), or it can include any other suitable power supply.

Sensors 152 can include, for example, sensors 52 such as those described above with reference to the example of FIG. 1. Sensors 152 can include additional sensors that may or may not otherwise be included on a standard vehicle 10 with which the shadow ADS detection and activation system 200 is implemented. In the illustrated example, sensors 152 include vehicle acceleration sensors 212, vehicle speed sensors 214, wheelspin sensors 216 (e.g., one for each wheel), a tire pressure monitoring system (TPMS) 220, accelerometers such as a 3-axis accelerometer 222 to detect roll, pitch and yaw of the vehicle, vehicle clearance sensors 224, left-right and front-rear slip ratio sensors 226, and environmental sensors 228 (e.g., to detect salinity or other environmental conditions). Additional sensors 232 can also be included as may be appropriate for a given implementation of shadow ADS detection and activation system 200.

Vehicle systems 158 can include any of a number of different vehicle components or subsystems used to control or monitor various aspects of the vehicle and its performance. In this example, the vehicle systems 158 include a GPS or other vehicle positioning system 272; torque splitters 274 that can control distribution of power among the vehicle wheels such as, for example, by controlling front/rear and left/right torque split; engine control circuits 276 to control the operation of engine (e.g. Internal combustion engine 14); cooling systems 278 to provide cooling for the motors, power electronics, the engine, or other vehicle systems; suspension system 280 such as, for example, an adjustable-height air suspension system, or an adjustable-damping suspension system; and other vehicle systems 282.

During operation, shadow ADS detection/activation circuit 210 can receive information from various vehicle sensors to determine whether shadow ADS should be activated. Communication circuit 201 can be used to transmit and receive information between shadow ADS detection/activation circuit 210 and sensors 152, and shadow ADS detection/activation circuit 210 and vehicle systems 158. Also, sensors 152 may communicate with vehicle systems 158 directly or indirectly (e.g., via communication circuit 201 or otherwise).

In various embodiments, communication circuit 201 can be configured to receive data and other information from sensors 152 that is used in determining whether to activate shadow ADS. Additionally, communication circuit 201 can be used to send an activation signal or other activation information to various vehicle systems 158 as part of entering a shadow ADS mode. For example, as described in more detail below, communication circuit 201 can be used to send signals to one or more of: torque splitters 274 to control front/rear torque split and left/right torque split; motor controllers 276 to, for example, control motor torque, motor speed of the various motors in the system; ICE control circuit 276 to, for example, control power to engine 14 (e.g., to shut down the engine so all power goes to the rear motors, to ensure the engine is running to charge the batteries or allow more power to flow to the motors); cooling system (e.g., 278 to increase cooling system flow for one or more motors and their associated electronics); suspension system 280 (e.g., to increase ground clearance such as by increasing the ride height using the air suspension). The decision regarding what action to take via these various vehicle systems 158 can be made based on the information detected by sensors 152. Examples of this are described in more detail below.

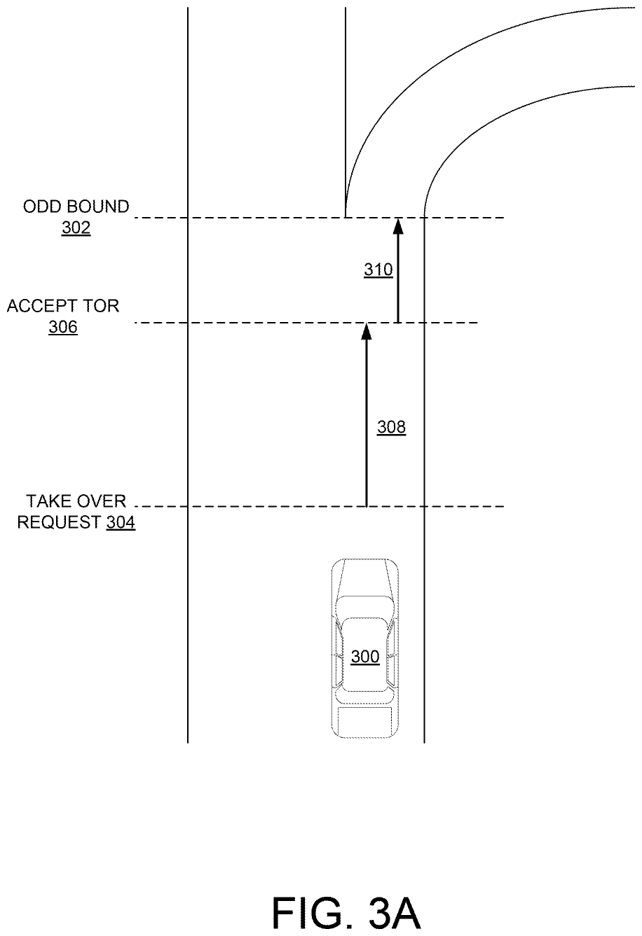

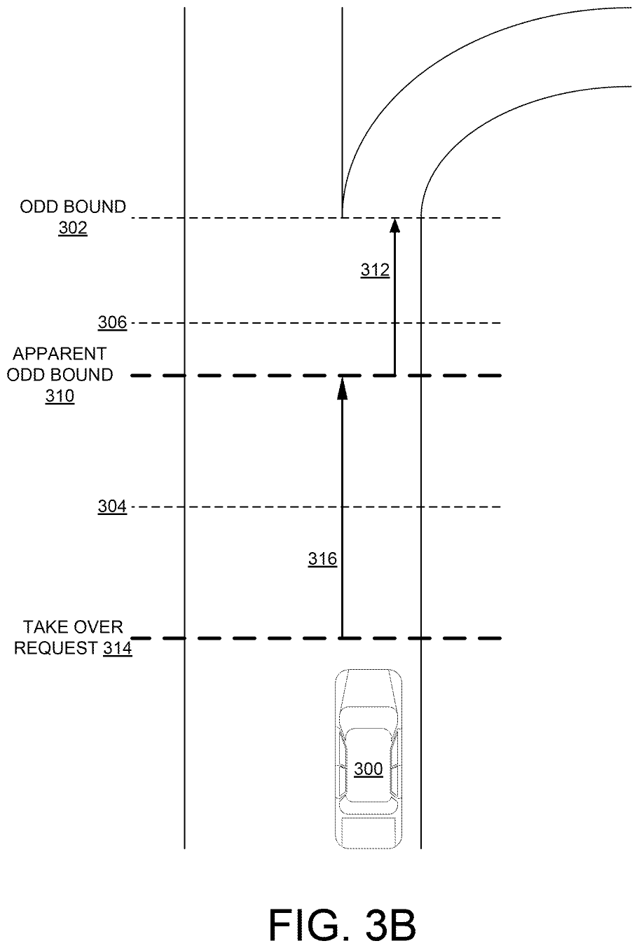

FIG. 3A illustrates an example driving scenario where shadow ADS features may be traditionally used. Here, vehicle 300 may travel on a highway and approach a turn off point or exit ramp. Vehicle 300 may not be able to continue automated driving at the turn off due to the sudden curve in the road. Therefore, the ODD bound 302 may be right before the vehicle takes the curve. Takeover request 304 may be issued to the driver at a time prior to ODD bound 302. The driver may be notified of the time period 308 where the driver can accept the takeover request. When the driver accepts the takeover request at time 306, vehicle 300 may transition away from the ADS features during time period 310 and initiate manual driving. In the situation of FIG. 3A, if the driver does not accept the takeover request by ODD bound 302, the vehicle system may begin to activate safety features. In this example, vehicle 300 may slow down or stop the vehicle to prevent the vehicle from taking the curve. Alternatively, the vehicle may pull over to the side of the road.

FIG. 3B illustrates a similar scenario to FIG. 3A applying the systems and methods described herein. The times highlighted in FIG. 3A are illustrated in FIG. 3B for reference. In FIG. 3B, the ODD bound 302 may be the same, i.e. right before the curve. An apparent ODD bound 310 may be set prior to ODD bound 302. As described above, apparent ODD bound 310 can refer to the boundary where a vehicle should activate safety features such as slowing down the vehicle, pulling over, etc. The system can determine apparent ODD bound 310 based on geographical data, vehicle system data, or environmental conditions. For example, in situations of heavy rain, a vehicle may require additional time to slowly brake to a complete stop due to the risk of hydroplaning. The vehicle system may apply specific safety features based on the specific driving situation. As an example, the vehicle system may determine that the safety features should comprise applying brakes to stop vehicle 300 before or at ODD bound 302. The vehicle system may then apply brakes accordingly to slow vehicle 300 during time period 312 such that the vehicle comes to a complete stop at ODD bound 302.

Takeover request 314 may be earlier than takeover request 304. Here, takeover request 314 may depend on the apparent ODD bound or driver conditions. In some embodiments, takeover request 314 may be applied at a time interval 316 before apparent ODD bound 314. In some embodiments, time interval 316 may be a default value based on the situation. In some embodiments, time interval 316 may be selected by the drive. In other embodiments, time interval 316 may be determined based on the driver's conditions. As mentioned above, the system can determine a driver's conditions by receiving various data on the driver. Data may reflect historical driving performance, sensor data (e.g. video or facial recognition), driving trends of the local population, or other factors that affect a driver's performance. The system can assess the mental fitness of a driver based on physical queues that can be detected. For example, a drunk driver may be falling asleep behind the wheel or swaying. The driver's physical actions can affect how the vehicle perceives the driver's character. The system can also receive data on the historical performance of the driver. The driver may be more cautious in executing safety maneuvers and may require more time to accept the takeover request, or vice versa, the driver may be more aggressive and requires less time to accept the request. The system can also receive data on the local population. For example, drivers in a particular region may be known to drive a certain speed over or under the speed limit. The system can use these speeds to determine the time to the ODD bound and accordingly, the time to initiate a takeover request. The system can consider all of the available data to tailor a takeover request to the specific driver.

The system may apply various indicators as the time for a takeover request decreases. Indicators can include increased beeping, flashing icons on the dashboard, or audio cues. The system's data on the driver may apply specific indicators according to the driver's condition. For example, if a driver is asleep, the vehicle may use louder audio cues to wake up the driver. Environmental data may also affect the indicators. For example, the vehicle may apply visual lighting to alert a driver if the vehicle is traveling at night. The sensor data, historical data, and environmental data received by the vehicle can be tied to all aspects of shadow ADS application to align the vehicle's actions with the driver's behavior.

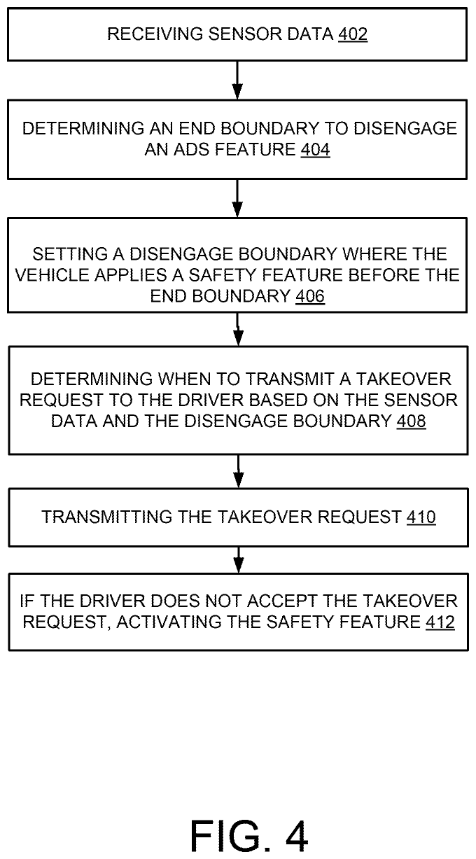

FIG. 4 illustrates an example method implementing the systems described herein. At block 402, the system can receive sensor data. As described above, sensor data can comprise any data collected on the driver, including video data, audio data, facial recognition, eye movement, or other data that can be used to determine a driver's character, mental fitness, or alertness.

At block 404, the system can determine an end boundary to disengage an ADS feature. As described above, the ODD boundary can refer to the area where an ADS feature was designed to operate in. The ODD bound can be determined in terms of the latest time an ADS system can be applied before capabilities are exceeded. The ODD bound can be determined based on environmental conditions, driving conditions, driver actions or mistakes, or specific situations affecting the safety of the driver.

At block 406, the system can set a disengage boundary where the vehicle applies a safety feature before the end boundary. As described above, the apparent ODD bound can refer to the boundary where a vehicle should activate safety features such as slowing down the vehicle, pulling over, etc. The apparent ODD bound can be a boundary applied earlier than the ODD bound to reduce or eliminate risk by providing the vehicle system additional time to activate safety features based on the conditions. The vehicle system may apply specific safety features based on the specific driving situation.

At block 408, the system can determine when to transmit a takeover request to the driver based on the sensor data and disengage boundary. The takeover request may be applied at a time interval before the disengage boundary, i.e. the apparent ODD bound. The time interval may be a default value based on the situation, may be selected by the driver, or may be determined based on the driver's conditions. The system can determine a driver's condition based on data received. Data may reflect historical driving performance, sensor data (e.g. video or facial recognition), driving trends of the local population, or other factors that affect a driver's performance. The system can consider all of the available data to tailor a takeover request to the specific driver.

At block 410, the system can transmit the takeover request. The takeover request may comprise a notification where the driver can accept control of the vehicle. The driver may also disengage the ADS feature manually. As described above, the system may apply various indicators as the time for a takeover request decreases. Indicators can include increased beeping, flashing icons on the dashboard, or audio cues. The system's data on the driver may apply specific indicators according to the driver's condition. At block 412, the system can activate the safety feature if the driver does not accept the takeover request. As described above, the safety feature can be activated at the disengage boundary such that the vehicle is in a safe position at the end boundary.

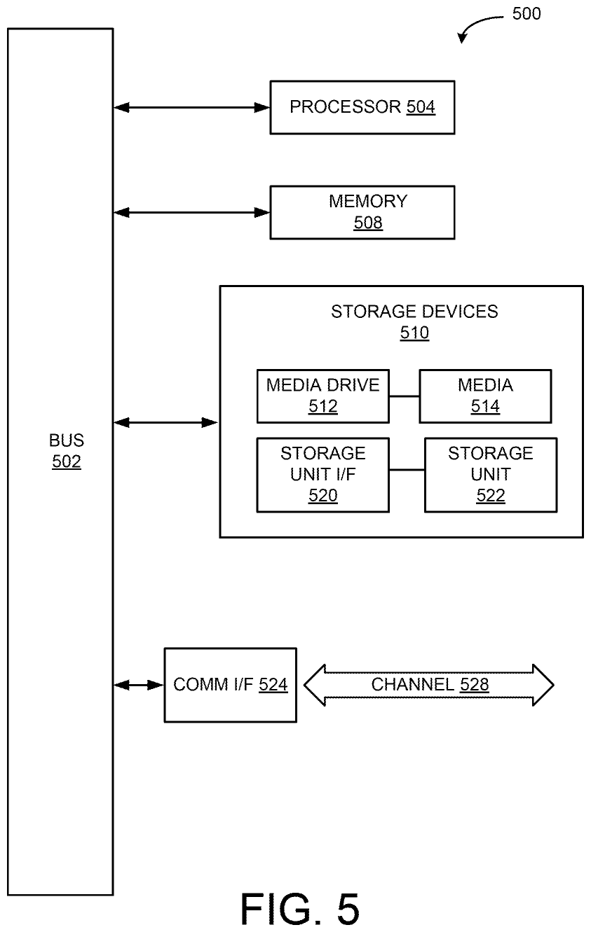

As used herein, the terms circuit and component might describe a given unit of functionality that can be performed in accordance with one or more embodiments of the present application. As used herein, a component might be implemented utilizing any form of hardware, software, or a combination thereof. For example, one or more processors, controllers, ASICs, PLAS, PALs, CPLDs, FPGAs, logical components, software routines or other mechanisms might be implemented to make up a component. Various components described herein may be implemented as discrete components or described functions and features can be shared in part or in total among one or more components. In other words, as would be apparent to one of ordinary skill in the art after reading this description, the various features and functionality described herein may be implemented in any given application. They can be implemented in one or more separate or shared components in various combinations and permutations. Although various features or functional elements may be individually described or claimed as separate components, it should be understood that these features/functionality can be shared among one or more common software and hardware elements. Such a description shall not require or imply that separate hardware or software components are used to implement such features or functionality.

Where components are implemented in whole or in part using software, these software elements can be implemented to operate with a computing or processing component capable of carrying out the functionality described with respect thereto. One such example computing component is shown in FIG. 5. Various embodiments are described in terms of this example-computing component 500. After reading this description, it will become apparent to a person skilled in the relevant art how to implement the application using other computing components or architectures.

Referring now to FIG. 5, computing component 500 may represent, for example, computing or processing capabilities found within a self-adjusting display, desktop, laptop, notebook, and tablet computers. They may be found in hand-held computing devices (tablets, PDA's, smart phones, cell phones, palmtops, etc.). They may be found in workstations or other devices with displays, servers, or any other type of special-purpose or general-purpose computing devices as may be desirable or appropriate for a given application or environment. Computing component 500 might also represent computing capabilities embedded within or otherwise available to a given device. For example, a computing component might be found in other electronic devices such as, for example, portable computing devices, and other electronic devices that might include some form of processing capability.

Computing component 500 might include, for example, one or more processors, controllers, control components, or other processing devices. Processor 504 might be implemented using a general-purpose or special-purpose processing engine such as, for example, a microprocessor, controller, or other control logic. Processor 504 may be connected to a bus 502. However, any communication medium can be used to facilitate interaction with other components of computing component 500 or to communicate externally.

Computing component 500 might also include one or more memory components, simply referred to herein as main memory 508. For example, random access memory (RAM) or other dynamic memory, might be used for storing information and instructions to be executed by processor 504. Main memory 508 might also be used for storing temporary variables or other intermediate information during execution of instructions to be executed by processor 504. Computing component 500 might likewise include a read only memory (“ROM”) or other static storage device coupled to bus 502 for storing static information and instructions for processor 504.

The computing component 500 might also include one or more various forms of information storage mechanism 510, which might include, for example, a media drive 512 and a storage unit interface 520. The media drive 512 might include a drive or other mechanism to support fixed or removable storage media 514. For example, a hard disk drive, a solid-state drive, a magnetic tape drive, an optical drive, a compact disc (CD) or digital video disc (DVD) drive (R or RW), or other removable or fixed media drive might be provided. Storage media 514 might include, for example, a hard disk, an integrated circuit assembly, magnetic tape, cartridge, optical disk, a CD or DVD. Storage media 514 may be any other fixed or removable medium that is read by, written to or accessed by media drive 512. As these examples illustrate, the storage media 514 can include a computer usable storage medium having stored therein computer software or data.

In alternative embodiments, information storage mechanism 510 might include other similar instrumentalities for allowing computer programs or other instructions or data to be loaded into computing component 500. Such instrumentalities might include, for example, a fixed or removable storage unit 522 and an interface 520. Examples of such storage units 522 and interfaces 520 can include a program cartridge and cartridge interface, a removable memory (for example, a flash memory or other removable memory component) and memory slot. Other examples may include a PCMCIA slot and card, and other fixed or removable storage units 522 and interfaces 520 that allow software and data to be transferred from storage unit 522 to computing component 500.

Computing component 500 might also include a communications interface 524. Communications interface 524 might be used to allow software and data to be transferred between computing component 500 and external devices. Examples of communications interface 524 might include a modem or softmodem, a network interface (such as Ethernet, network interface card, IEEE 802.XX or other interface). Other examples include a communications port (such as for example, a USB port, IR port, RS232 port Bluetooth® interface, or other port), or other communications interface. Software/data transferred via communications interface 524 may be carried on signals, which can be electronic, electromagnetic (which includes optical) or other signals capable of being exchanged by a given communications interface 524. These signals might be provided to communications interface 524 via a channel 528. Channel 528 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media. Such media may be, e.g., memory 508, storage unit 520, media 514, and channel 528. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing component 500 to perform features or functions of the present application as discussed herein.

It should be understood that the various features, aspects and functionality described in one or more of the individual embodiments are not limited in their applicability to the particular embodiment with which they are described. Instead, they can be applied, alone or in various combinations, to one or more other embodiments, whether or not such embodiments are described and whether or not such features are presented as being a part of a described embodiment. Thus, the breadth and scope of the present application should not be limited by any of the above-described exemplary embodiments.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like; and adjectives such as “conventional,” “traditional,” “normal,” “standard,” “known.” Terms of similar meaning should not be construed as limiting the item described to a given time period or to an item available as of a given time. Instead, they should be read to encompass conventional, traditional, normal, or standard technologies that may be available or known now or at any time in the future. Where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “component” does not imply that the aspects or functionality described or claimed as part of the component are all configured in a common package. Indeed, any or all of the various aspects of a component, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A method for applying shadow assisted driving systems (ADS) to a vehicle, comprising:
receiving sensor data;
delivering a takeover request to the vehicle operator based on the sensor data;
determining an end boundary to disengage an ADS feature from the vehicle;
setting a disengage boundary that occurs before the end boundary;
determining when the vehicle operator responds to the takeover request based on the sensor data; and
causing the ADS to shadow the vehicle operator based on a determination that the vehicle operator did not take over operation of the vehicle at the disengage boundary.

2. The method of claim 1, further comprising activating a safety feature at the disengage boundary or maintaining the safety feature if already activated.

3. The method of claim 1, wherein the sensor data comprises data on the driver's character.

4. The method of claim 1, wherein delivering the takeover request comprises displaying a visual or audio indicator to the driver.

5. The method of claim 1, further comprising delivering the takeover request for a time interval before activating a safety feature.

6. The method of claim 5, wherein the time interval is based on the sensor data, environmental data, historical driving performance, or cloud data.

7. The method of claim 5, wherein the time interval is a value set by the driver.

8. The method of claim 5, further comprising:
determining, based on the sensor data, that the driver requires additional time to accept the takeover request; and
extending the time interval.

9. The method of claim 1, wherein the end boundary comprises a latest time the vehicle can apply the ADS feature.

10. A control system for a vehicle, comprising:
a processor; and
a memory coupled to the processor to store instructions, which when executed by the processor, cause the processor to:
receive sensor data;
determine an end boundary to disengage an ADS feature from the vehicle;
set a disengage boundary that occurs before the end boundary;
deliver a takeover request for a time interval to the vehicle operator based on the sensor data and the disengage boundary;
determine when the vehicle operator responds to the takeover request based on the sensor data; and
cause the ADS to shadow the vehicle operator based on a determination that the vehicle operator did not take over operation of the vehicle at the disengage boundary.

11. The control system of claim 9, wherein the processor is further configured to activate a safety feature at the disengage boundary.

12. The control system of claim 9, wherein delivering the takeover request comprises displaying a visual or audio indicator to the driver.

13. The control system of claim 9, wherein the time interval is based on the sensor data, environmental data, and historical driving performance.

14. The control system of claim 9, wherein the time interval is a value set by the driver.

15. The control system of claim 9, wherein the processor is further configured to:
determine, based on the sensor data, that the driver requires additional time to accept the takeover request; and
extend the time interval.

16. The control system of claim 9, wherein the end boundary comprises a latest time the vehicle can apply the ADS feature.

17. A non-transitory machine-readable medium having instructions stored therein, which when executed by a processor, cause the processor to:
receive sensor data;
determine an end boundary to disengage an ADS feature from a vehicle;
set a disengage boundary that occurs before the end boundary;
deliver a takeover request for a time interval to the vehicle operator based on the sensor data and the disengage boundary;
determine when the vehicle operator responds to the takeover request based on the sensor data; and
cause the ADS to shadow the vehicle operator based on a determination that the vehicle operator did not take over operation of the vehicle at the disengage boundary.

18. The non-transitory machine-readable medium of claim 15, wherein the sensor data comprises data on the driver's character.

19. The non-transitory machine-readable medium of claim 15, wherein the processor is further caused to transmit the takeover request for a time interval before activating a safety feature.

20. The non-transitory machine-readable medium of claim 17, wherein the time interval is based on the sensor data, environmental data, and historical driving performance.
